(19) United States
(12) Patent Application Publication
(10) Pub. No.: US 2008/0306976 A1
(43) Pub. Date: Dec. 11, 2008

(54) PROCESS FOR DYNAMIC TABLE CONVERSION

(75) Inventors: Mawuena K. Agbeblewu, Durham, NC (US); Fernando Arturo Montero Aguilar, Guadalajara Jalisco (MX); Caroline J. Schneyder Kastelberg, New Hill, NC (US)

Correspondence Address: SCULLY, SCOTT, MURPHY & PRESSER, P.C., 400 GARDEN CITY PLAZA, SUITE 300, GARDEN CITY, NY, 11530, US

(73) Assignee: INTERNATIONAL BUSINESS MACHINES CORPORATION, Armonk, NY (US)

(21) Appl. No.: 11/758,198

(22) Filed: Jun. 5, 2007

(51) Int. Cl. G06F 17/30

(52) U.S. Cl. 707/101; 707/E17.044

(57) ABSTRACT

A method and system are disclosed for converting data from a source table having a multitude of source fields to a target table having a multitude of target fields, the method comprising the steps of extracting data from the source table, downloading the extracted data into a flat file, and dynamically creating a conversion program to convert said data in the flat file, said conversion program including a custom table name of the target table and a plurality of input parameters. The method comprises the further step of using the conversion program to convert the data in the flat file, including the step of specifying each field of the source table to be converted by providing the name of said each field, and new and old values for said each field. The converted data are then uploaded into the target table.

### BACKGROUND OF THE INVENTION

1. Field of the Invention

The present invention generally relates to converting data tables, and more specifically, to a method and system for creation of dynamic conversion programs for converting data tables.

2. Background Art

Computers are very powerful tools for storing and providing access to vast amounts of information. Computer databases are a common mechanism for storing information in the form of a database on computer systems while providing easy access to users. The size of a database may be several megabytes to several gigabytes or more, depending on the application. A typical database is a predetermined, organized collection of related information stored as “records“having “fields” or “attributes” of information, which may be viewed as “tables” of records.

Sometimes it is necessary or desirable to convert a field in a database from one value to another, or to convert several fields. For example, for SAP migration projects, it is necessary to convert fields in many custom tables. Although the fields to be converted in the different tables are the same types, each table has a different format, and the standard practice is to develop a unique program for each table to be migrated and/or converted, which incurs a large development overhead.

### SUMMARY OF THE INVENTION

An object of this invention is to improve methods and systems for converting database tables.

Another object of the present invention is to convert custom table data without the need to develop unique conversion programs for each table.

A further object of the invention is to reduce the time required for database table conversion.

These and other objectives are attained with a method and system for converting data from a source table having a multitude of source fields to a target table having a multitude of target fields. The method comprises the steps of extracting data from the source table, downloading the extracted data into a flat file, and dynamically creating a conversion program to convert said data in the flat file, said conversion program including a custom table name of the target table and a plurality of input parameters. The method comprises the further step of using the conversion program to convert the data in the flat file, including the step of specifying each field of the source table to be converted by providing the name of said each field, and new and old values for said each field. The converted data are then uploaded into the target table.

In the preferred embodiment of this invention, described in detail below, an existing tool is used to download the custom tables into flat files. The new common table conversion tool will use the custom table name combined with the input parameters to dynamically create a conversion program. The generated program will then convert the data in the flat files by using the relevant table layout defined in the SAP data dictionary, together with the input parameters. The value of the source field in the input parameters can be specified to define a single value to be replaced, or a wild card (*) that specifies that all values in the field are to be replaced with the same value in the target field. It is also possible to specify multiple parameters for the same field, when more than one value is to be converted. The existing tool is used to upload the converted table into the custom table in the target client.

Using one common tool to convert the custom table data, we are able to avoid the additional development required for unique programs for each table, and this also enables us to automate the execution process, thereby reducing the time required for the development, as well as the execution process for the table conversions.

Further benefits and advantages of this invention will become apparent from a consideration of the following detailed description, given with reference to the accompanying drawing, which specifies and shows preferred embodiments of the invention.

### BRIEF DESCRIPTION OF THE DRAWINGS

FIG. 1 illustrates a table field conversion method according to a preferred embodiment of this invention.

FIG. 2 shows a computer system that may be used to practice the present invention.

### DETAILED DESCRIPTION OF THE PREFERRED EMBODIMENTS

The present invention, generally, provides a method and system for converting database tables. The present invention may be used with a wide range of database tables, and the invention is very well suited for SAP data migration projects.

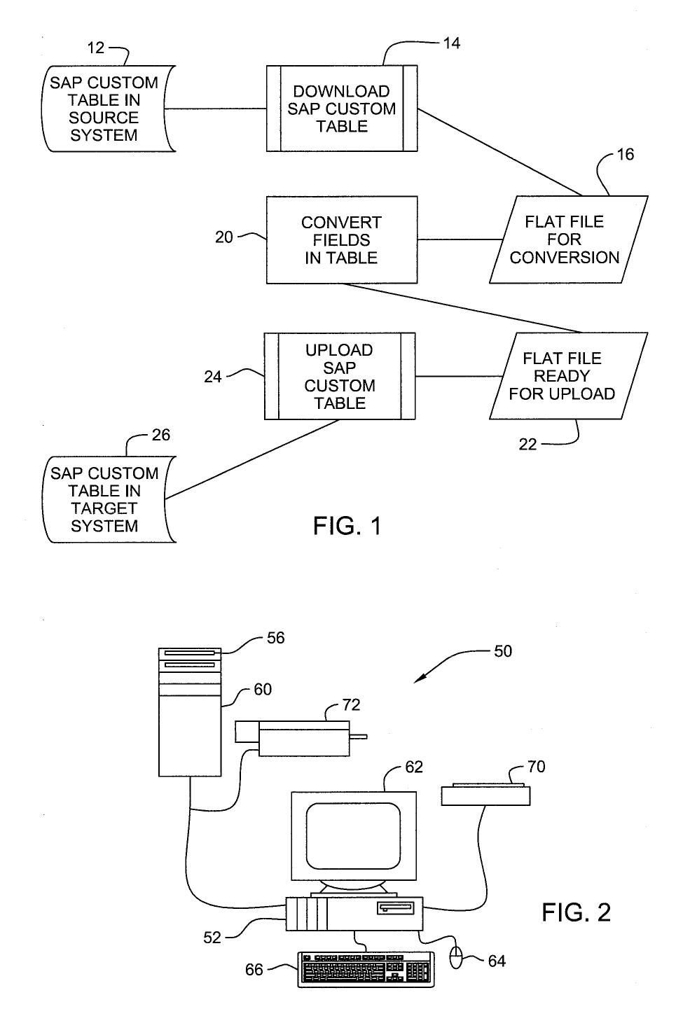

FIG. 1 illustrates a preferred procedure embodying the present invention. In this procedure, at step 12, data is extracted from the custom table that is to be converted. Then, at step 14, the data are downloaded into a flat file, represented at 16. Any suitable tool or tools may be used to extract and download the custom table date into flat file 16.

A flat file is a computer file that can only be read or written sequentially. It is comprised of one or more records, and each record includes one or more field instances. Each field instance can contain a data value, or be omitted. In some applications, all records in a flat file are of the same type; however, most usages allow a flat file to have more than one record type.

With reference again to FIG. 1, step 20 of the process is to convert fields in the table. A generated program is used to convert the data in the flat file by using the relevant table layout defined in, for example, the SAP data dictionary, together with the input parameters.

The value of the source field in the input parameters can be specified to define a single value to be replaced, or a wild card (*) that specifies that all values in the field are to be replaced with the same value in the target field. It is also possible to specify multiple parameters for the same field, when more than one value is to be converted.

As represented at 22, the result of this data conversion is a flat file ready for upload. Then, as represented at 24, the converted data are uploaded into a custom table, and then, at step 26, this file is uploaded into the target system. Any suitable tool or procedure may be used to upload the table into the target system.

The present invention may be used to convert a wide range of tables. For example, the invention is very well suited for SAP data migration. In SAP, there are tables with data, and each of these has a defined unique structure. When it is necessary to convert data in a table, for example an SAP custom table that is used to hold parameters for a custom application, this invention makes it possible to do a mass update of the table downloading, converting and uploading the data in flat files to populate the table with data.

The requirement for the file is that the data must be in columns, in the same sequence as the fields of the table, separated by a comma, pipe, or other appropriate field delimiter.

It is only necessary to tell the program which table is being converted, and the utility program will read the input file, convert the required fields and prepare the flat file to be uploaded into the table.

As will be readily apparent to those skilled in the art, the present invention, or aspects of the invention, can be realized in hardware, software, or a combination of hardware and software. Any kind of computer/server system(s)—or other apparatus adapted for carrying out methods described herein—is suited. A typical combination of hardware and software could be a general-purpose computer system with a computer program that, when loaded and executed, carries out the respective methods described herein. Alternatively, a specific use computer, containing specialized hardware for carrying out one or more of the functional tasks of the invention, could be utilized.

For example, FIG. 2 illustrates a computer system 50 which may be used in the implementation of the present invention may be carried out. Computer system includes a processing unit 52 that houses a processor, memory and other systems components that implement a general purpose processing system that may execute a computer program product comprising media, for example a floppy disc that may be read by processing unit 502 through floppy drive 54.

The program product may also be stored on hard disk drives within processing unit 52 or may be located on a remote system 56 such as a server 60, coupled to processing unit 52, via a network interface, such as an Ethernet interface. Monitor 62, mouse 64 and keyboard 66 are coupled to processing unit 52, to provide user interaction. Scanner 70 and printer 72 are provided for document input and output. Printer 72 is shown coupled to processing unit 52 via a network connection, but may be coupled directly to the processing unit. Scanner 70 is shown coupled to processing unit 52 directly, but it should be understood that peripherals might be network coupled or direct coupled without affecting the ability of workstation computer 50 to perform the method of, or aspects of, the invention.

The present invention, or aspects of the invention, can also be embodied in a computer program product, which comprises all the respective features enabling the implementation of the methods described herein, and which—when loaded in a computer system—is able to carry out these methods. Computer program, software program, program, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

While it is apparent that the invention herein disclosed is well calculated to fulfill the objects stated above, it will be appreciated that numerous modifications and embodiments may be devised by those skilled in the art, and it is intended that the appended claims cover all such modifications and embodiments as fall within the true spirit and scope of the present invention.

What is claimed is:

1. A method of converting data from a source table having a multitude of source fields to a target table having a multitude of target fields, the method comprising the steps of:
extracting data from the source table;
downloading the extracted data into a flat file;
dynamically creating a conversion program to convert said data in the flat file, said conversion program including a custom table name of the target table and a plurality of input parameters;
using said conversion program to convert the data in the flat file, including the step of specifying each field of the source table to be converted by providing the name of said each field, and new and old values for said each field; and
uploading the converted data into the target table.

2. A method according to claim 1, wherein the using step includes the step of specifying multiple parameters for the same fields in the source table and the target table, when more than one value is to be converted.

3. A method according to claim 1, wherein said input parameters define a single value to be replaced in identified fields of the source table.

4. A method according to claim 1, wherein the input parameters define s wild card that specifies that all values in an identified field of the source target are to be replaced with a single value in a target field of the target table.
